(19) United States
(12) Patent Application Publication
(10) Pub. No.: US 2022/0332507 A1
(43) Pub. Date: Oct. 20, 2022

(54) MULTI-FUNCTION ORDER FULFILLMENT SYSTEM WITH GRID STORAGE

(71) Applicant: Dematic Corp., Grand Rapids, MI (US)

(72) Inventors: William R. Boer, Wayland, MI (US); Carla Inger, Wayland, MI (US)

(21) Appl. No.: 17/724,878

(22) Filed: Apr. 20, 2022

Related U.S. Application Data
(60) Provisional application No. 63/177,075, filed on Apr. 20, 2021.

(51) Int. Cl. B65G 1/137; B65G 1/04; G06Q 10/08

(52) U.S. Cl. CPC B65G 1/1376; B65G 1/0492; G06Q 10/087

(57) ABSTRACT

A system and methods for utilizing a grid storage array for high rate picking in a micro-fulfilment facility. The system includes a grid storage array and multiple transfer ports that are dedicated to a particular directional function, i.e. discharge ports and intake ports. The system includes a multi-function workstation that can operate as either a picking station or a decant station. A conveyor loop is provided and includes right-angle-transfers (RATs) and accumulators to transport and sequence the flow of storage bins and order totes. The combination and configuration of the grid storage array, conveyor loop, and multi-function workstation optimizes space utilization which is particularly beneficial in micro-fulfilment facilities where space is at a premium.

### CROSS REFERENCE TO RELATED APPLICATION

The present application claims priority of U.S. provisional application Ser. No. 63/177,075, filed Apr. 20, 2021, which is hereby incorporated by reference herein in its entirety.

### FIELD OF THE INVENTION

The present invention is directed to an order fulfilment system, and in particular an order fulfilment system with a grid storage system.

### BACKGROUND OF THE INVENTION

Automated grid storage arrays or systems are commonly utilized in warehouse settings due to their inherent space usage efficiency as compared to some other known automated warehousing solutions. Grid storage arrays require a substantially smaller footprint than many other common automated storage and retrieval systems, such as multi-shuttle systems for example. Thus, grid storage arrays provide certain advantages for small scale warehouses, such as those typically found in micro-fulfillment facilities (e.g. grocery stores, convenience stores, etc.). Grid storage arrays are also well-suited to low-rate throughput operations in which physical space is limited. Grid storage is not necessarily ideal for high pick rate and high throughput operation due to low output volume and high potential for resource conflicts. For example, typical transfer ports for grid storage arrays are dual directional and operate to both input totes into the storage array and to discharge totes from the storage array, thus resource conflicts arise when totes need to be input and discharged at the same time.

Standard goods to person (GTP) order fulfilment solutions include an operator whom picks inventory items to a predetermined order container that is positioned at a pick location within the GTP workstation. Once the order picking for that order container is completed, the order container is discharged or moved from the pick location to be transported away from the GTP workstation. Typically, the GTP workstation requires placement or replacement of empty order containers, such as totes or cartons, at the empty pick locations within the GTP workstation so that a new order can then be picked into the newly placed empty order container. It is typical that the placement or replacement of empty order containers may be done manually by the operator, requiring the operator to move or reach to retrieve an empty order container and then place it in the empty pick location.

Order fulfillment is a complex operation. Vendor trucks deliver inventory cartons that must be unloaded from the truck and decanted into donor totes or other receptacles to be stored in an automated warehouse as inventory. A customer order is fulfilled at a goods-to-person (GTP) or robot (GTR) workstation which receives donor or inventory totes retrieved from the warehouse and containing inventory items from for a particular order. At the workstation, the operator typically picks multiple orders at a time and must move between the multiple donor totes and multiple order totes that may be present at the workstation, each possibly containing multiple inventory items and/or one or more orders.

### SUMMARY OF THE INVENTION

The present invention provides a system and methods for operating a micro-fulfilment facility with a grid storage array for high rate picking. The system includes an automated grid storage array and multiple transfer ports that are operated uni-directionally to reduce conflicts and thereby increase throughput. In other words, the transfer ports are dedicated to only one of two directional types or formats during an operational period, either as discharge ports or intake ports. The system includes a multi-function workstation that is operable as either a picking station or a decant station. A conveyor loop is provided between the storage array and the workstation. The conveyor loop includes right-angle-transfers (RATs) and accumulators to transport and sequence the flow of storage bins and order totes. The combination and configuration of the grid storage array, conveyor loop, and multi-function workstation optimize space utilization in micro-fulfilment facilities where space is at a premium. Additional features of the system include a tote stacking system that stacks order totes into empty storage bins and a removable decant platform for facilitating decant operations.

According to one form of the present invention, an order fulfillment system is provided for an automated, robotic grid storage array that includes a plurality of storage bins stored within the storage array. The storage array includes a plurality of transfer ports that are operable to discharge bins from the storage array and/or intake bins into the storage array. Preferably, each of the transfer ports operates in only one direction at all times to reduce or eliminate potential conflicts at the transfer ports. The system includes a conveyor system for transporting storage bins to and from the storage array and the transfer ports. The conveyor system includes an endless conveyor loop that enables delivery of storage bins and order totes to any function (e.g. workstations or transfer ports, for example) within the system, as required. A multi-function workstation is provided to perform picking functions and/or decant functions. Preferably, the conveyer and workstation include multiple accumulators and right angle transfers to facilitate efficient movement of storage bins and order totes within the system. In one aspect, the workstation includes order tote presentation positions (e.g. three presentation positions) with each presentation position configured to receive an order tote and present it to an operator at the workstation in an ergonomic position for the operator.

In one aspect, the workstation includes a right angle transfer at one or more of the presentation positions to move downstream order totes, such as ones that are not completed, out of the way of upstream order totes, such as those that are complete or fully filled, and thus, permitting the completed upstream order totes to be transported onto the conveyor loop. In another aspect, an order tote stacker is provided to stack order totes inside of a storage bin. The storage bin with order tote nested therein may be transported to the storage array so that the order tote may be buffered until the order is required, either to finish the order with later received inventory or when the customer has arrived to pick up the order.

In yet another aspect, a removable and selectively deployable decant transfer surface is provided adjacent to the workstation. The transfer surface provides a work surface to receive empty storage bins and present the storage bins to the operator in an ergonomic manner. The operator is then able to decant items from a pallet or vendor case near the workstation and place the decanted items into a storage bin on the decant transfer surface. The decant transfer surface may include a ball transfer system, casters to transport the decant transfer surface to and from the workstation, and/or be mounted to the conveyor or workstation with hinges so that the surface may be folded out of the way, such as for when the system is performing picking functions.

In still another aspect, the system includes an empty order tote supply system that is positioned above the conveyor system and the workstation. The tote supply system consistently delivers empty order totes to the workstation substantially without interference from or with the conveyor system and the workstation. The tote supply system saves the operator time and wear and tear by not having to move out of the workstation to retrieve empty order totes.

According to another form of the present invention, a method is provided for fulfilling orders in an order fulfilment facility, such as a facility utilizing an order fulfilment system as described previously. The method includes selecting a storage bin containing a desired inventory item or items from the automated grid storage array and transporting the bin to a discharge transfer port. The discharge port discharges the storage bin to a conveyor and the conveyor transports the discharged bin to a multi-function workstation. The method includes positioning the discharged bin at a pick position alongside the conveyor system that is adjacent to the workstation. The positioning of storage bins alongside the conveyor loop enables an operator to pick items from one of the storage bins in the pick positions and then place the picked items in an order tote that is positioned at an order tote presentation position of the workstation. An operator picks the necessary items based on instructions received from a warehouse management system and/or a user interface. The order tote may be fully filled, and thus completed, or may be partially filled in the event that there is insufficient inventory in the grid storage array or facility to fill the remainder of the order. If a completed order tote is ready to ship or deliver to a customer, it may be transported from the workstation to a downstream function, such as a packing station or a customer order pick up portal. However, if an order tote is not fully complete or a customer is not ready to receive their order, the order tote may be sent to the storage array to be buffered until sufficient inventory is available or the customer is ready for the order. In some embodiments, the storage array is specifically designed to store storage bin and not order totes, such that it is not feasible for the order totes to be input directly into the storage array. Thus, the method may include transferring a completed order tote or partially completed order tote, with the conveyor system, to a tote stacker system. The stacker system stacks an order tote inside of a storage bin. The storage bin with the order tote nested therein is then transported to a transfer intake port to be input and stored in the storage array.

According to yet another form of the present invention, a method is provided for decanting items in an order fulfilment facility, such as a facility utilizing an order fulfilment system as described above. The method includes transporting an empty (or partially empty) storage bin within a grid storage array to a discharge transfer port and discharging the empty storage bin to a conveyor system. The conveyor system transports the storage bin to a workstation where an operator retrieves and positions the storage bin onto a decant surface or platform that is positioned alongside the conveyor system. The operator decants items from a vendor case or pallet that is positioned near the workstation and then places the decanted items into a storage bin positioned at the decant platform. When a storage bin has been completed (e.g. fully filled, partially filled, etc.) the method includes transporting the completed storage bin to an intake transfer port of the grid storage array and inputting the completed storage bin into the storage array. The storage bin remains in storage until its items are required for an order during picking functions or until more items are to be decanted into the bin during decant operations.

Accordingly, a system and method are provided for utilizing a grid storage array for high rate picking within an order fulfilment facility, such as for micro-fulfilment operations. The system includes a grid storage array and multiple discharge ports and intake ports. The system includes a multi-function workstation that may operate as either a picking station or a decant station. A conveyor loop is provided between the storage array and the workstation and includes right-angle-transfers (RATs) and accumulators to transport and sequence the flow of storage bins and order totes, as controlled by a warehouse management system or the like. The combination and configuration of the grid storage array, conveyor loop, and multi-function workstation may enable optimization of space utilization in micro-fulfilment facilities where space is at a premium and may enable high rate picking solutions while utilizing space-saving hardware.

These and other objects, advantages, purposes and features of this invention will become apparent upon review of the following specification in conjunction with the drawings.

### BRIEF DESCRIPTION OF THE DRAWINGS

FIG. 1 is a top plan view of a multi-function order fulfilment system with a grid storage system, in accordance with the present invention;

FIG. 1A is an enlarged view of the region designated 1A in FIG. 1;

FIG. 2 is a perspective view of a left side of the multi-function order fulfilment system of FIG. 1, depicted with a multi-functional workstation in a picking configuration;

FIG. 3 is a perspective view of a right side of the multi-function order fulfilment system of FIG. 1, depicted with a multi-functional workstation in a decant configuration;

FIG. 4 is a schematic diagram of an exemplary multi-functional workstation in a picking configuration, similar to that of FIG. 2;

FIG. 5 is a schematic diagram of an exemplary multi-functional workstation in a decant configuration, similar to that of FIG. 3;

FIG. 6 is a diagram of an exemplary method for picking operations in an order fulfilment facility, in accordance with the present invention; and

FIG. 7 is a diagram of an exemplary method for decant operations in an order fulfilment facility, in accordance with the present invention.

### DESCRIPTION OF THE PREFERRED EMBODIMENTS

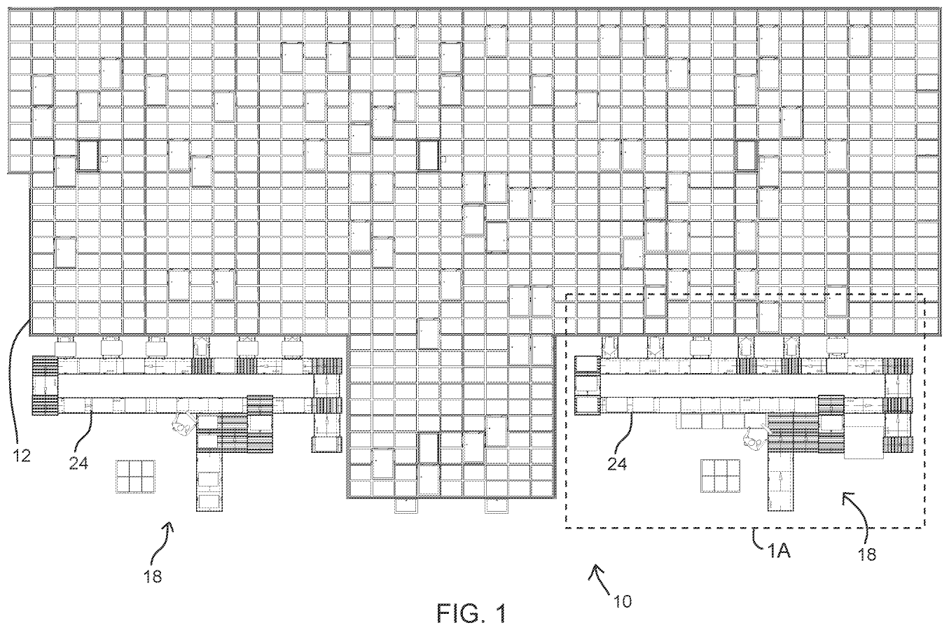

Referring now to the drawings and the illustrative embodiments depicted therein, methods and an order fulfilment system 10 are provided for the operation of an order fulfilment facility that utilizes a grid storage array or system 12 which reduces the storage footprint within the facility (FIGS. 1-7). The system 10 includes several transfer ports or cells 14 installed in the storage array 12 and the quantity, configuration, and sequence of transfer ports 14 enable high rate discharge and input for moving grid storage totes or bins 16 in and out of the storage array 12. The high rate discharge and input enables a goods to person (GTP) workstation 18 to receive items stored in the storage array 12 or to input inbound or decanted items into the storage array 12 at a high rate without resource or item starvation at the workstation 18. Each of the transfer ports 14 are preferably operated in a one-way manner such that some of the ports 14 discharge storage bins 16 from the storage array 12 and the other ports 14 input storage bins 16 from the storage array 12. The multiple transfer ports 14 operating in a one way manner facilitates high rate, low conflict operation of the order fulfilment facility. In addition to storing inventory items, the storage array 12 is also operable to store completed of partially completed order totes or bins 20 within storage bins 16, such that the storage array 12 acts as a buffer for order totes 20 when the order tote is not ready for shipment or is awaiting additional items to be received in inventory to complete the order. The workstation(s) 18 may be reconfigurable to function in a picking function and/or a decanting function, as will be explained in further detail below. The reconfigurable nature of the workstation 18 may improve space usage efficiency as only one reconfigurable workstation can perform the functions of a dedicated pick station and a dedicated decant station while requiring about the same amount of space as only one dedicated workstation.

The system 10 and methods may be incorporated with other micro-fulfilment systems and methods may improve or optimize a facilities throughput, customer time management, customer interface, labor management, and space use efficiency, in addition to other advantages. For an example, the system 10 may be coupled with a customer order pickup portal such as described in commonly owned and assigned U.S. patent application Ser. No. 17/547,643, filed on Dec. 10, 2021. The system 10 and methods may be incorporated with or utilize some methods for operation of a flexible fulfilment center such as sequencing of storage bins with order containers and buffering full or partially full customer orders in the storage array 12. Some exemplary sequencing methods and systems are described in commonly owned and assigned U.S. Patent Application Pub. No. 2022/0106121A1, published on Apr. 7, 2022.

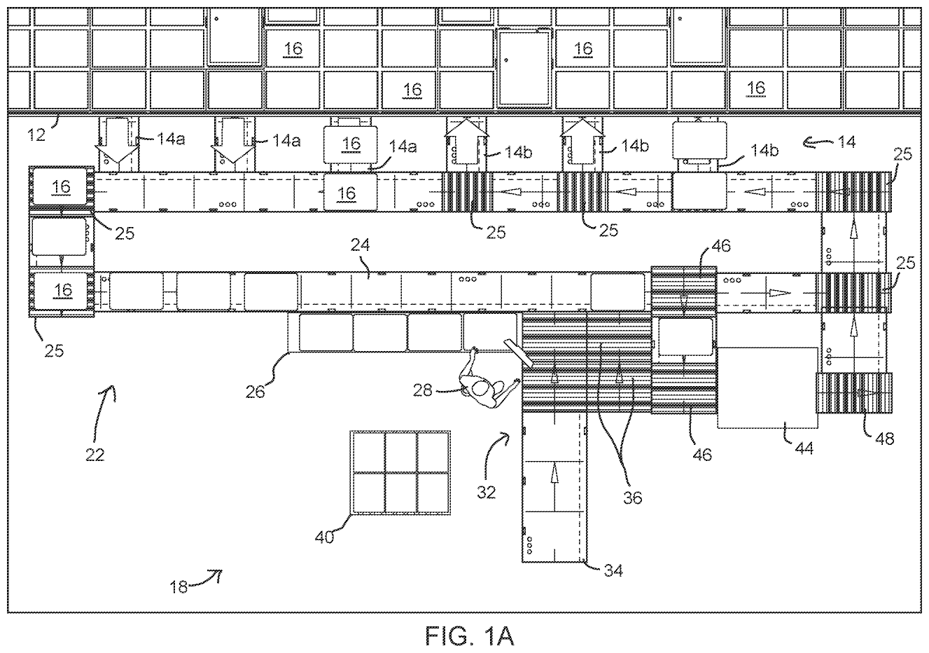

Referring to FIGS. 1-5, an order fulfillment system 10 is provided for high-rate order picking with a grid storage array 12 type automated storage and retrieval system. The grid storage array 12 automatically stores and retrieves storage bins 16 within the array and includes a robotic operator to perform the storage and retrieval operations. The grid storage array 12 includes three outbound or discharge transfer ports 14a and three inbound or intake transfer ports 14b (FIGS. 1-5). The discharge ports 14a are operable to discharge storage bins 16 from the grid storage array 12 and the intake ports 14b are operable to induct storage bins 16 into the grid storage array 12. A conveyor system 22 includes an endless conveyor loop 24 that is positioned alongside the storage array 12 adjacent to the discharge ports 14a and intake ports 14b (FIGS. 2-5). The ports 14a and 14b are in transport communication with the conveyor loop 24 to enable storage bins 16 to transfer between the conveyor loop 24 and the ports 14a, 14b. The conveyor loop includes right angle transfer (RAT) conveyors 25 at the ends of the loop 24 as well as at each of the intake ports 14b (FIGS. 2-5). The conveyor loop 24 also includes accumulator conveyors to sequence storage bins 16 and order totes 20 as they travel along the loop 24. The RATs facilitate efficient transportation of storage bins 16 and order totes 20 within a relatively small spatial footprint.

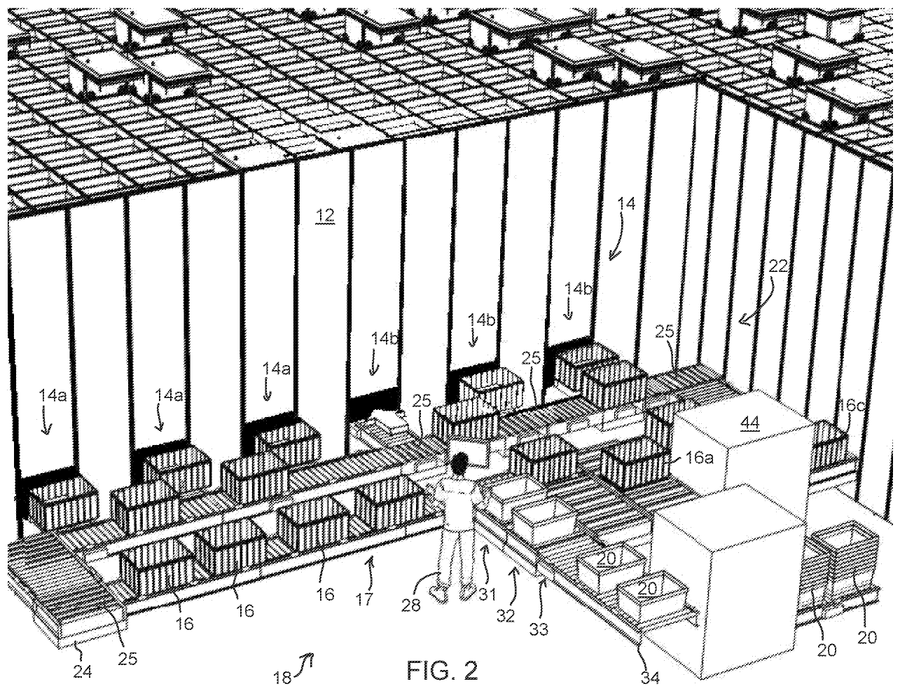

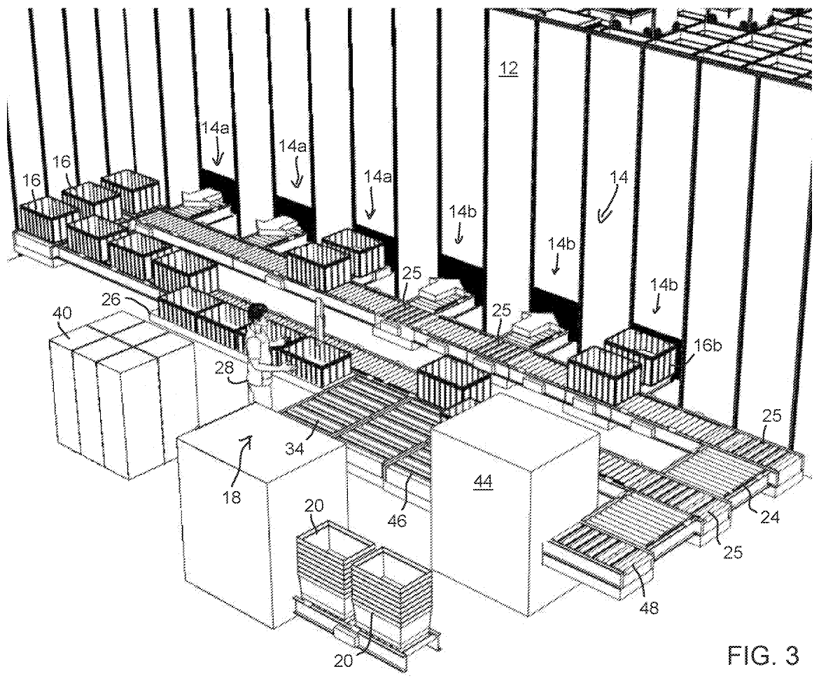

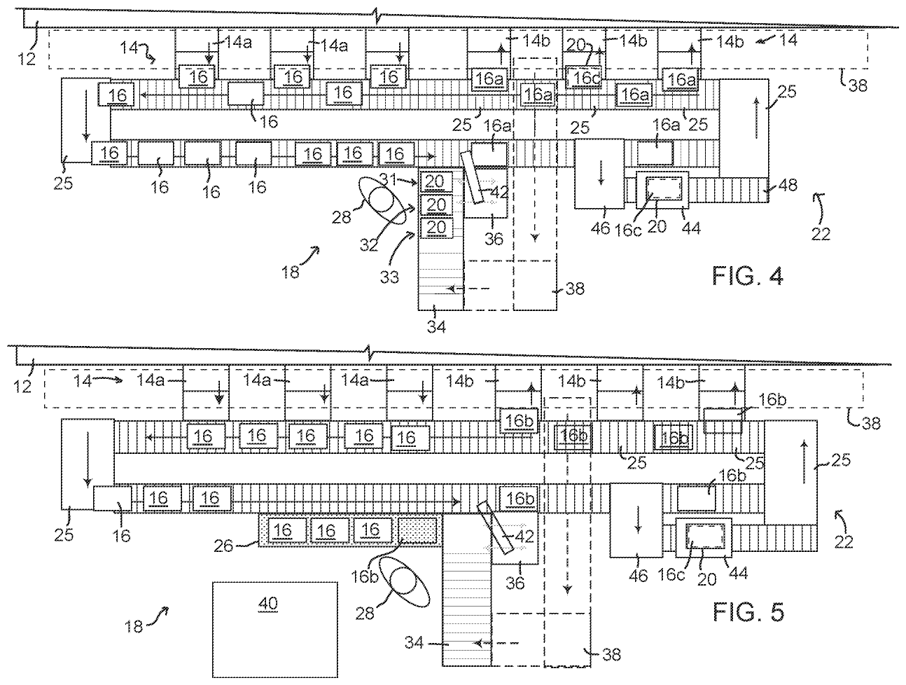

A workstation 18 is positioned adjacent to a portion of the conveyor loop 24 and is in transport communication with the conveyor loop 24 (FIGS. 1-5). As depicted in the illustrative embodiment of FIG. 1, two or more workstations 18 may be provided within the order fulfilment facility, as desired or as required based on throughput requirements. However, a single workstation 18 may be sufficient for a particular facility. In the illustrative embodiment, the workstation 18 is a goods to person (GTP) workstation (i.e. human operated workstation) that is reconfigurable to perform multiple functions including: (i) picking operations as best shown in the illustrative embodiment of FIGS. 2 and 4; and (ii) decanting operations as best shown in the illustrative embodiment of FIGS. 3 and 5. It will be appreciated that a goods to robot (GTR) workstation (i.e. robot operated workstation) may also be provided for workstation 18. A removeable accessory decant transfer surface 26 is provided with the workstation 18 to provide a working surface for the operator 28 when performing decant operations (see FIGS. 1, 3, and 5). The transfer surface 26 may include various structures permitting the surface 26 to be moved out of the way when not needed. For example, the transfer surface 26 may by a roller transfer table that is supported on casters and the operator 28 can maneuver the surface 26 as desired, or the surface 26 may be hingedly supported along the conveyor loop 24 such that the operator 28 may fold the surface 26 out of the way when desired. The picking and decanting functions will be discussed in further detail below. Preferably, the workstation is shaped and dimensioned such that all functions performed by the operator 28 are performed at substantially the same vertical height, thereby providing an optimized ergonomic workstation to improve working conditions for the operator 28. For example, the conveyor system 22 may be positioned at substantially the same height as all of the work surfaces of the workstation 18.

The workstation includes three picking positions: a first picking position 31, a second picking position 32, and a third picking position 33, that are provided to support order totes 20 to be filled with order items by the operator 28, as best shown in FIGS. 2 and 4. The picking positions 31, 32, and 33 can be referred to as order tote presentation positions as the order totes 20 are presented to the operator 28 at picking positions 31, 32, and 33. A warehouse management system, or similar control system, may direct the picking operations, such as by giving visual instructions to the operator 28 via a user-interface 42 provided with the workstation 18 (FIG. 4). The picking positions 31, 32, 33 include a conveyor 34, such as a segmented belt conveyor, which operates perpendicular to the portion of the conveyor loop 24 at which the workstation 18 is positioned. The conveyor 34 may be dual directional such that order totes 20 on the conveyor may be moved toward or away from the conveyor loop 24. The conveyor 34 is preferably operable to index and sequence the order totes 20 and to discharge any full order totes 20 to the conveyor loop 24. A pair of RATs 36 are positioned behind (i.e. adjacent) the first and second picking positions 31 and 32. The RATs 36 enable the system 10 to move incomplete downstream order totes 20 out of the way to allow any full or completed upstream order totes 20 to pass by and onto the conveyor loop 24. For example, if the order tote 20 at the third position 33 is complete and ready to discharge, but the totes at the first and second positions 31, 32 are not complete, the system 10 will move the totes from the first and second positions 31 and 32 with the RATs 36 to allow the order tote 20 from the third position 33 to pass to the conveyor loop 24. The RATs will transfer the totes back to the first and second positions 31 and 32 once the tote from third position 33 has passed. As order totes are filled/completed and then discharged, an empty order tote 20 is dispensed onto the conveyor 34 (FIG. 2). The system 10 includes an optional order tote replenishment system 38 that is superjacent to the conveyor system 22 and the workstation 18 (the replenishment system is shown in phantom in FIGS. 4 and 5). The order tote replenishment system 38 provides a continuous supply of empty order totes 20 to the workstation 18 and conveyor 34 so that the operator does not need to move from their working position to retrieve empty order totes. The replenishment system 38 operates with minimal or no interference with the rest of the system 10.

Once a storage bin 16 is no longer needed at the workstation 18, it is returned to the storage array 12 via the conveyor loop 24 and inducted into the storage array 12 by one of the intake ports 14b. Storage bins 16 that have items remaining in them are placed in the storage array 12 for fulfilment of future orders. Fully depleted and empty storage bins 16a (FIG. 4) may be routed to the storage array 12 and buffered until decant operations are required or they may be routed to a tote stacking system 44 that is adjacent to the workstation 18 (FIGS. 2-5). It will be appreciated that a storage bin 16, such as a fully depleted storage bin 16a, returning to the storage array 12 may be immediately called for, and in that situation the storage bin 16a may remain on the conveyor loop 24 and bypass the storage array 12 and return to the workstation 18 instead. The tote stacking system 44 is provided to insert an order tote 20 into an empty storage bin 16a so that an order tote 20 may be inducted into the storage array 12. In the illustrated embodiment, the order tote 20 is shaped and dimensioned to nest within a storage bin 16. The tote stacking system 44 is positioned adjacent to the conveyor loop 24 and a pair of RATs 46 (FIG. 1) between the stacking system 44 and conveyor loop 24 direct empty storage bins 16 and order totes 20 to the stacking system 44. Another RAT 48 is positioned downstream of the stacking system 44 and directs order totes nested in storage bins 16c to the conveyor loop 24.

As an example, if an order tote is only partially filled and there is not proper inventory in the storage array 12 to complete the order, that order tote 20 may be inducted into the storage array 12. The storage array 12 buffers the partially filled order tote 20 until there is sufficient inventory in the storage array 12. The inventory may be replenished through decant operations which are described below. Once there is sufficient inventory, the warehouse management system will release the storage bin 16c that contains the order tote 20 and it will be transported to the workstation 18 where an operator will retrieve the order tote 20 from the storage bin 16 and proceed with filling the remainder of the order. As another example, an order may be completed, but the customer may not have arrived to retrieve the order, so the order tote 20 may be inducted into the storage array 20 and buffered until the customer arrives. When necessary, completed order totes 20 are transported to a downstream function, such as a packing function or a customer pick-up portal.

When the workstation 18 is operating in the decant configuration with the decant transfer surface 26 deployed in the operable position (see FIG. 5), the transfer surface 26 provides a support surface for several storage bins 16 (e.g. four storage bins). The storage bins 16 are presented to the operator 28 on the transfer surface 26 so that the operator 28 can place decanted items into one of the totes on the transfer surface 26. During decant operations, empty storage bins 16 are dispensed from the storage array 12 via the discharge ports 14a and the conveyor loop 24 transports the bins 16 toward the workstation 18. An operator 28 can pull an empty storage bin 16 onto the transfer surface 26. It is contemplated that RATs may be provided with the conveyor loop 24 to automatically transfer storage bins 16 onto the transfer surface 26. The operator 28 may readily retrieve items from a vendor case, pallet 40, etc., that is positioned near the workstation 18 and place those items into one of the bins on the transfer surface 26 (FIGS. 3 and 5). A warehouse management system, or similar control system, may direct the decant operations, such as by giving visual instructions to the operator 28 via the user-interface 42 provided with the workstation (FIG. 5). After filling, a full or complete storage bin 16b (FIGS. 3 and 5) is pushed onto the conveyor loop 24 by the operator 28 and the conveyor loop 24 transfers the full storage bin 16b to an intake port 14b to be stored in the storage array 12 until the items in the bin are needed to fulfil a customer order. It will be appreciated that a storage bin 16, such as a full storage bin 16b, returning to the storage array may be immediately called for, and in that situation, the storage bin 16b may remain on the conveyor loop 24 and bypass the storage array 12 and immediately return to the workstation 18 instead.

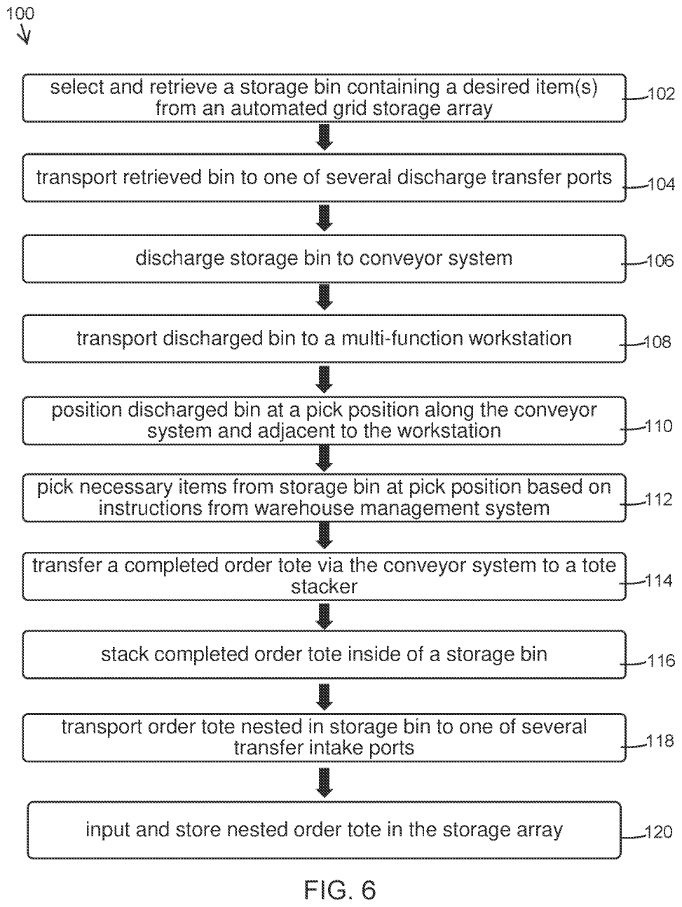

Referring to the illustrative embodiment of FIG. 6, a method 100 is provided for fulfilling orders in an order fulfilment facility, such as a facility utilizing an order fulfilment system 10 as described in the illustrative embodiments above and shown in FIGS. 1-5. The order fulfilment system 10 includes an automated grid storage array 12, discharge transfer ports 14a and intake transfer ports 14b, a conveyor system 22 with an endless conveyor loop 24 and a goods to person workstation 18. The method 100 includes selecting 102 a storage bin 16 containing a desired item or items from the automated grid storage array 12 and transporting 104 the bin to one of the discharge transfer ports 14a. The discharge port 14a discharges 106 the storage bin 16 to the conveyor loop 24 and the conveyor loop 24 transports 108 the discharged bin to the workstation 18. The method includes positioning 110 the discharged bin at a pick position 17 (FIG. 2) along the conveyor system 22 that is adjacent to the workstation 18. The positioning of storage bins 16 along the conveyor loop 24 enables an operator to pick items from one of the storage bins 20 in the pick positions 17 and then place the picked items in an order tote 20 at one of three order tote presentation positions 31, 32, and 33.

The operator 28 picks 112 the necessary items based on instructions received from a warehouse management system and a user interface 42 (FIG. 6). The order tote 20 may be fully filled and completed or may be partially filled in the event that there is insufficient inventory to fill the remainder of the order. If a completed order tote 20 is ready to ship or deliver to a customer, it can be transported from the workstation 18 to a downstream function, such as a packing station or a customer order pick up portal. However, if an order tote is not fully complete or a customer is not ready to receive their order, the order tote may be sent to the storage array 12 to be buffered until sufficient inventory is available or the customer is ready for the order. In the exemplary embodiment, the method 100 includes transferring 114 the completed order tote 20, with the conveyor system 22, to a tote stacker system 44. The stacker system 44 stacks 116 a completed order tote 20 inside of a storage bin 16. The order tote nested in the storage bin 16c is then transported 118 to one of the transfer intake ports 14b to be input 120 and stored in the storage array 12.

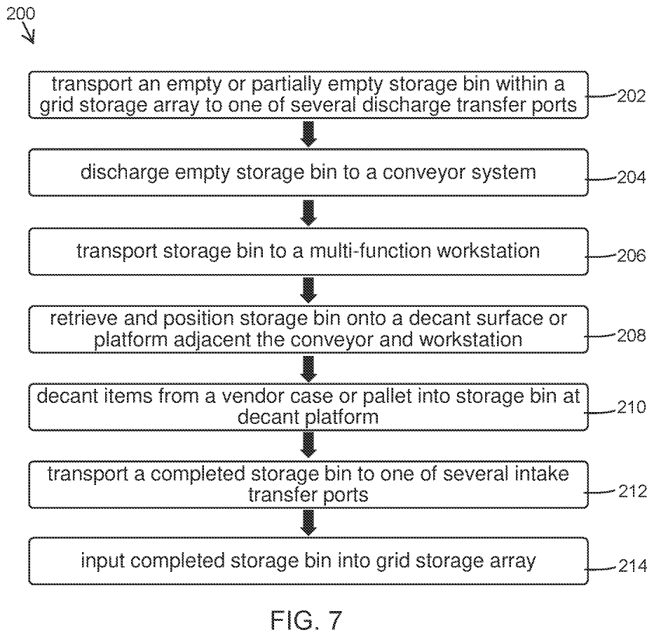

Referring to the illustrative embodiment of FIG. 7, a method 200 is provided for decanting items in an order fulfilment facility, such as a facility utilizing an order fulfilment system 10 as described in the illustrative embodiments above and shown in FIGS. 1-5. The method 200 includes transporting 202 an empty (or partially empty) storage bin 16 from within a grid storage array 12 to a discharge transfer port 14a and discharging 204 the empty storage bin 16 to a conveyor system 22. The conveyor system 22 transports 206 the storage bin 16 to a workstation 18 where an operator or the conveyor retrieves and positions 208 the storage bin onto a decant surface or platform 26 that is alongside the conveyor system 22. The operator 28 decants 210 items from a vendor case or pallet 40 that is positioned near the workstation 18 and the operator 28 places the decanted items into a storage bin at the decant platform 26. When a storage bin 20 has been completed (e.g. fully filled or partially filled) the method includes transporting 212 the completed storage bin to an intake transfer ports 14b and inputting 214 the completed storage bin into the grid storage array 12 with one of the ports 14b. The storage bin remains in storage until its items are required for an order during picking function or until more items are to be decanted into the bin during decant operations.

Thus, the system and method are provided for utilizing a grid storage array for high rate picking. The system includes the grid storage array and multiple transfer ports that are dedicated to a particular directional function, i.e. discharge ports and intake ports. The system includes a multi-function workstation that can operate as either a picking station or a decant station. A conveyor loop is provided and includes right-angle-transfers (RATs) and accumulators to transport and sequence the flow of storage bins and order totes. The combination and configuration of the grid storage array, conveyor loop, and multi-function workstation may optimize space utilization in micro-fulfilment facilities where space is at a premium.

Changes and modifications in the specifically described embodiments can be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. An order fulfillment system comprising:
a robotic grid storage array comprising a plurality of storage bins;
a plurality of transfer ports disposed in said storage array, each of said plurality of ports operable to perform at least one chosen from (i) discharge bins from said storage array and (ii) intake bins into said storage array;
a conveyor system comprising an endless conveyor loop in transport communication with each of said plurality of ports;
a multi-function workstation in transport communication with said conveyor loop and operable to perform each of picking functions and decant functions;
wherein said conveyor loop is operable to transport bins between said storage array and said workstation, said workstation.

2. The order fulfillment system of claim 1, wherein some of said plurality of ports are configured to discharge bins from said storage array and the remainder of said plurality of ports are configured to intake bins into said storage array.

3. The order fulfillment system of claim 1, wherein said workstation comprises a plurality of order tote presentation positions, each presentation position configured to receive an order tote and present that order tote to an operator at said workstation.

4. The order fulfillment system of claim 3, wherein said workstation further comprises a right angle transfer at at least one of said presentation positions, said right angle transfer configured to move downstream order totes out of the way of upstream order totes to permit the upstream order totes to be transported toward said conveyor loop.

5. The order fulfillment system of claim 4, further comprising an order tote stacker operable to stack order totes inside of a storage bin, wherein a storage bin with an order tote is transported on said conveyor loop to said storage array and the order tote in the storage bin is buffered in said storage array until the order is required.

6. The order fulfillment system of claim 4, further comprising a decant transfer surface that is selectively deployable adjacent to said workstation, said transfer surface configured to receive a plurality of empty storage bins and to present the storage bins to an operator such that the operator is able to decant items from received pallets into one of the plurality of empty storage bins.

7. The order fulfillment system of claim 1, wherein said conveyor system further comprises a plurality of right angle transfers disposed throughout said conveyor system including said conveyer loop, wherein at least some of said plurality of right angle transfers is operable to transfer storage bins perpendicularly from said conveyor loop to a corresponding one of said plurality of ports.

8. The order fulfillment system of claim 1, further comprising an empty order tote supply system positioned superjacent to said conveyor system and said workstation, said tote supply system is operable to deliver empty order totes to said workstation without interference from said conveyor system and said workstation.

9. A method for fulfilling orders in an order fulfilment facility, said method comprising:
selecting a storage bin containing a desired item from an automated grid storage array;
transporting the storage bin to one of a plurality of transfer ports disposed in the storage array;
discharging the storage bin, with one of the transfer ports, from the storage array to a conveyor system that is in transport communication with the transfer port;
transporting the discharged bin, with the conveyor system, to a pick workstation;
positioning the discharged bin at one of a plurality of pick positions alongside the conveyor system and adjacent to the workstation such that an operator may retrieve items from a storage bin at one of the plurality of pick positions and place the items in an order tote at one of a plurality of order tote presentation positions of the workstation;
picking items, with the operator, from a storage bin at one of the plurality of pick positions into an order tote at one of the plurality of order tote presentation positions;
wherein when an order tote has been completed, transporting, with the conveyor system, the completed order tote to one of the plurality of transfer ports; and
inputting, with the transfer port, the completed order tote into the grid storage array to buffer until that order tote is required.

10. The method of claim 9, wherein when an order tote has been completed, said method further comprises transferring the completed order tote, with the conveyor system, to an order tote stacker and stacking a completed order tote inside of a storage, wherein said transporting the completed order tote comprises transporting, with the conveyor system, the storage bin with the completed order tote to one of the plurality of transfer ports, and said inputting the completed order tote comprises inputting the storage bin with the completed order tote into the grid storage array to buffer until that order tote is required.

11. The method of claim 9, further comprising moving a first one of the order totes from a downstream one of the plurality of order tote presentation positions, transferring a second one of the order totes from an upstream one of the plurality of order tote presentation positions past the downstream order tote presentation position to the conveyor system, and returning the first one of the order totes to one of the plurality of order tote presentation positions to continue picking operations.

12. The method of claim 9, wherein the operator is a robot.

13. The method of claim 9, wherein the operator is a human.

14. The method of claim 9, wherein some of the plurality of transfer ports are configured to discharge bins from the storage array to the conveyor system and the remainder of the plurality of transfer ports are configured to intake bins from the conveyor system into the storage array.

15. The method of claim 9, wherein the pick workstation is configured to perform each of picking functions and decant functions.

16. A method for decanting items in an order fulfilment facility, said method comprising:
transporting an empty storage bin within an automated grid storage array to one of a plurality of transfer ports disposed in the storage array;
discharging the empty storage bin, with one of the transfer ports, from the storage array to a conveyor system that is in transport communication with the transfer port;
transporting the empty storage bin, with the conveyor system, to a decant workstation;
positioning the empty storage bin at one of a plurality of decant positions of the workstation adjacent to the conveyor system such that an operator may retrieve items from a vendor case proximate the workstation and place the items in a storage bin at one of the plurality of decant positions in the workstation;
decanting items, with the operator, from the vendor case into a storage bin at one of the plurality of decant positions;
wherein when a storage bin has been completed, transporting, with the conveyor system, the completed storage bin to one of the plurality of transfer ports; and
inputting, with the transfer port, the completed storage bin into the grid storage array.

17. The method of claim 16, wherein the operator is a robot.

18. The method of claim 16, wherein the operator is a human.

19. The method of claim 16, wherein some of the plurality of transfer ports are configured to discharge bins from the storage array to the conveyor system and the remainder of the plurality of transfer ports are configured to intake bins from the conveyor system into the storage array.

20. The method of claim 16, wherein the decant workstation is configured to perform each of picking functions and decant functions.
